(19) United States
(12) Patent Application Publication
(10) Pub. No.: US 2024/0101155 A1
(43) Pub. Date: Mar. 28, 2024

(54) ROUTE PLANNER AND METHOD FOR ROUTE PLANNING

(71) Applicant: TOYOTA JIDOSHA KABUSHIKI KAISHA, Toyota-shi (JP)

(72) Inventors: Hiroshi Nakamura, Chofu-shi (JP); Katsuhiro Sakai, Kawasaki-shi (JP); Taisuke Sugaiwa, Chofu-shi (JP); Naoki Nagasaka, Nagakute-shi (JP); Ray Kawanishi, Chofu-shi (JP)

(73) Assignee: TOYOTA JIDOSHA KABUSHIKI KAISHA, Toyota-shi (JP)

(21) Appl. No.: 18/369,863

(22) Filed: Sep. 19, 2023

(30) Foreign Application Priority Data
Sep. 22, 2022 (JP) 2022-151836

(51) Int. Cl. B60W 60/00; G06V 20/58; G06V 40/16

(52) U.S. Cl. CPC B60W 60/0017; G06V 20/58; G06V 40/161; B60W 2420/42; B60W 2554/20; B60W 2554/4029; B60W 2555/60

(57) ABSTRACT

A route planner detects a pedestrian from surrounding data representing a situation of surroundings of a vehicle, identifies a position of a pause-by object in the surroundings of the vehicle prompting the pedestrian to pause, creating a travel route over which the vehicle will travel when the pedestrian is detected, assuming the pedestrian will enter a road on which the vehicle will travel when the identified position of the pause-by object is not in the vicinity of the pedestrian, and assuming the pedestrian will not enter the road when the identified position of the pause-by object is in the vicinity of the pedestrian.

### CROSS-REFERENCE TO RELATED APPLICATION

This application claims priority to Japanese Patent Application No. 2022-151836 filed on Sep. 22, 2022, the entire contents of which are herein incorporated by reference.

### FIELD

The present disclosure relates to a route planner and a method for planning a travel route of a vehicle.

### BACKGROUND

A travel control device controlling travel of a vehicle by autonomous driving is required to control the travel of the vehicle in accordance with a travel route free from encounters with traffic participants such as pedestrians. A route planner plans a suitable travel route for autonomous driving in accordance with whether a pedestrian detected in surroundings of the vehicle will enter the road on which the vehicle is traveling.

For example, a jaywalking alarm device described in Japanese Unexamined Patent Publication No. 2012-238185 expects a possibility of a pedestrian in the vicinity of a road on which its vehicle is traveling crossing the road based on an orientation of a face of the pedestrian, for example, if pointed at another pedestrian crossing a crosswalk.

### SUMMARY

A pedestrian turning face to a road may seem to cross it but will not always actually cross it. If determining the possibility of the pedestrian crossing the road based on the orientation of his face and generating a travel route for autonomous driving so as to avoid encounters with pedestrians even when the possibility is lower than a threshold, the vehicle will stop on the travel route more than necessary, and the problem will arise such that the required time for destination will become longer, and that the vehicle cannot suitably travel on the road.

It is an object of the present disclosure to provide a route planner which can efficiently create a feasible travel route while securing safety of pedestrians.

The gist of the present disclosure is as follows:
(1) A route planner comprising a processor configured to:
detect a pedestrian from surrounding data representing a situation of surroundings of a vehicle,
identify a position of a pause-by object in the surroundings of the vehicle prompting the pedestrian to pause, and
create a travel route over which the vehicle will travel when the pedestrian is detected, assuming the pedestrian will enter a road on which the vehicle will travel when the identified position of the pause-by object is not in a vicinity of the pedestrian, and assuming the pedestrian will not enter the road when the identified position of the pause-by object is in the vicinity of the pedestrian.
(2) The route planner according to the above item (1), wherein the processor,
in the detection, further detects a facial orientation of the pedestrian from surrounding data, and
in the creation, creates the travel route assuming the pedestrian will not enter the road even when the pedestrian is detected and the identified position of the pause-by object is not in the vicinity of the pedestrian in a case where the facial orientation of the pedestrian is not toward the road.
(3) The route planner according to the above item (1) or (2), wherein the processor,
in the detection, further detects an entry-restricted state restricting entry of the pedestrian to the road from the surrounding data, and
In the creation, creates the travel route assuming the pedestrian will not enter the road when the pedestrian is detected and the entry-restricted state is detected.
(4) A method for route planning having a route planner creating a travel route of a vehicle execute a process comprising:
detecting a pedestrian from surrounding data representing a situation of surroundings of the vehicle,
identifying a position of a pause-by object in the surroundings of the vehicle prompting the pedestrian to pause,
creating a travel route over which the vehicle will travel when the pedestrian is detected, assuming the pedestrian will enter a road on which the vehicle will travel when the identified position of the pause-by object is not in a vicinity of the pedestrian, and assuming the pedestrian will not enter the road when the identified position of the pause-by object is in the vicinity of the pedestrian.
(5) A non-transitory computer-readable medium having a computer program for route planning stored therein, the computer program causing a computer mounted on a vehicle to execute a process comprising:
detecting a pedestrian from surrounding data representing a situation of surroundings of the vehicle,
identifying a position of a pause-by object in the surroundings of the vehicle prompting the pedestrian to pause,
creating a travel route over which the vehicle will travel when the pedestrian is detected, assuming the pedestrian will enter a road on which the vehicle will travel when the identified position of the pause-by object is not in a vicinity of the pedestrian, and assuming the pedestrian will not enter the road when the identified position of the pause-by object is in the vicinity of the pedestrian.

The route planner according to the present disclosure can efficiently create a feasible travel route while securing safety of pedestrians.

### BRIEF DESCRIPTION OF DRAWINGS

FIG. 1 schematically illustrates the configuration of a vehicle equipped with a route planner.

FIG. 2 schematically illustrates hardware of the route planner.

FIG. 3 is a functional block diagram of a processor included in the route planner.

FIG. 4 schematically illustrates a first example of route planning.

FIG. 5 schematically illustrates a second example of route planning.

FIG. 6 is a flowchart of a process for route planning.

### DESCRIPTION OF EMBODIMENTS

A route planner that can efficiently create a feasible travel route while securing safety of pedestrians will now be described in detail with reference to the attached drawings. The route planner detects a pedestrian from surrounding data representing a situation of surroundings of a vehicle. The route planner also identifies a position of a pause-by object in the surroundings of the vehicle. A pause-by object is an object by which a pedestrian is prompted to pause and include, for example, a bus stop, a taxi stand, a cross walk with a red pedestrian light, and a popular shop with a queue of customers. When a pedestrian is detected and the identified position of the pause-by object is not in the vicinity of the pedestrian, the route planner creates a travel route on which the vehicle will travel assuming the pedestrian will enter the road on which the vehicle will travel. On the other hand, when a pedestrian is detected and the identified position of the pause-by object is in the vicinity of the pedestrian, the route planner creates a travel route on which the vehicle will travel assuming the pedestrian will not enter the road.

A pedestrian in the present disclosure is not limited to a person who is walking and includes a person who has stopped or has been running. “Assuming the pedestrian will enter the road” includes determining the probability of a pedestrian entering the road being above a predetermined probability threshold (for example 5%). “Assuming the pedestrian will not enter the road” includes determining the probability of a pedestrian entering the road being below the predetermined probability threshold.

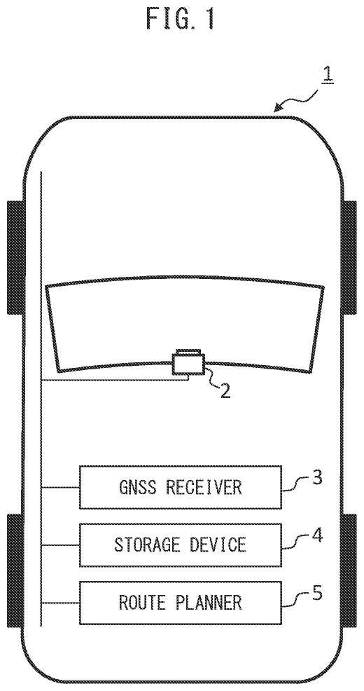

FIG. 1 schematically illustrates the configuration of a vehicle equipped with a route planner.

The vehicle 1 includes a surrounding camera 2, a GNSS (global navigation satellite system) receiver 3, a storage device 4, and a route planner 5. The surrounding camera 2, the GNSS receiver 3, and the storage device 4 are connected to the route planner 5 via an in-vehicle network conforming to a standard, such as a controller area network, so that they can communicate with each other.

The surrounding camera 2 is an example of a surrounding sensor for generating surrounding data in which the situation in the surroundings of the vehicle 1 is represented. The surrounding camera 2 includes a two-dimensional detector constructed from an array of optoelectronic transducers, such as CCD or C-MOS, having sensitivity to visible light and a focusing optical system that forms an image of a target region on the two-dimensional detector. The surrounding camera 2 is disposed, for example, in a front and upper area in the interior of the vehicle and oriented forward. The surrounding camera 2 takes a picture of the situation in the surroundings of the vehicle 1 through a windshield every predetermined capturing period (e.g., 1/30 to 1/10 seconds) and outputs surrounding images as surrounding data representing the situation in the surroundings of the vehicle 1. The vehicle 1 may also include, as a surrounding sensor, a sensor other than the surrounding sensor 2, for example, a LiDAR (light detection and ranging) sensor generating a range image whose pixels each has a value depending on the distances to an object represented in the pixels, based on the situation in the surroundings of the vehicle 1.

The GNSS receiver 3 receives GNSS signals from GNSS satellites at predetermined intervals and determines the position of the vehicle 1 based on the received GNSS signals. The GNSS receiver 3 outputs positioning signals each indicating the result of determination of the position of the vehicle 1 based on the GNSS signals to the route planner 5 via the in-vehicle network at predetermined intervals.

The storage device 4, which is an example of a storage unit, includes, for example, a hard disk drive or a nonvolatile semiconductor memory. The storage device 4 contains map data including information on features, such as lane lines, in association with their positions. Features stored in map data include pause-by objects such as bus stops, taxi stands, cross walks with red pedestrian lights, and popular shops with queues of customers.

The route planner 5 detects a pedestrian from surrounding data generated by the surrounding sensor 2. The route planner 5 identifies a position of a pause-by object in surroundings of the vehicle 1. The route planner 5 creates a travel route over which the vehicle will travel assuming the pedestrian will enter the road on which the vehicle will travel when the pedestrian is detected, and the identified position of the pause-by object is not in the vicinity of the pedestrian. On the other hand, the route planner 5 creates a travel route over which the vehicle will travel assuming the pedestrian will not enter the road on which the vehicle will travel when the pedestrian is detected, and the identified position of the pause-by object is in the vicinity of the pedestrian.

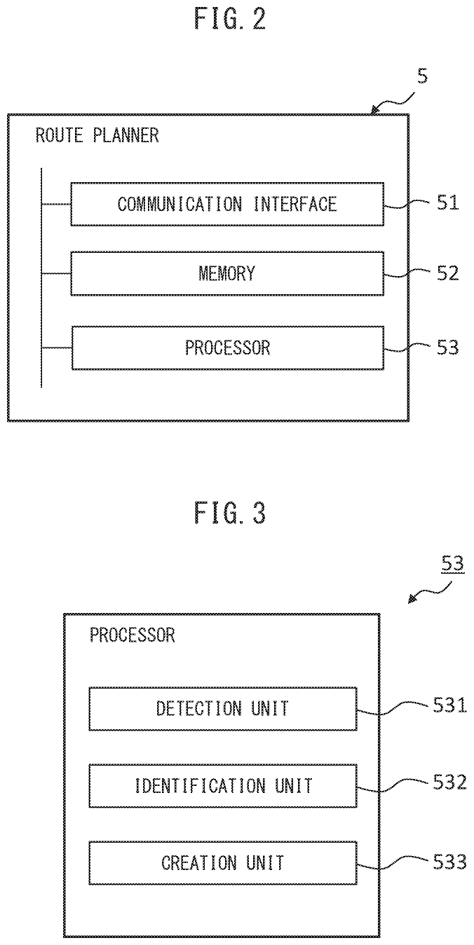

FIG. 2 schematically illustrates the hardware of the route planner 5. The route planner 5 is an electronic control unit (ECU) including a communication interface 51, a memory 52, and a processor 53.

The communication interface 51, which is an example of a communication unit, includes a communication interface circuit for connecting the route planner 5 to the in-vehicle network. The communication interface 51 provides received data for the processor 53. The communication interface 51 also outputs data provided from the processor 53 to an external device.

The memory 52 includes volatile and nonvolatile semiconductor memories. The memory 52 stores various types of data used for processing by the processor 53, e.g., parameters of a classifier for detecting a pedestrian from surrounding data. The memory 52 also stores various application programs, such as a program for route planning to execute a process for route planning.

The processor 53, which is an example of a control unit, includes one or more processors and a peripheral circuit thereof. The processor 53 may further include another operating circuit, such as a logic-arithmetic unit, an arithmetic unit, or a graphics processing unit.

FIG. 3 is a functional block diagram of the processor 53 included in the route planner 5.

As its functional blocks, the processor 53 of the route planner 5 includes a detection unit 531, an identification unit 532, and a creation unit 533. These units included in the processor 53 are functional modules implemented by a program executed on the processor 53. The computer program for achieving the functions of the units of the processor 53 may be provided in a form recorded on a computer-readable and portable medium, such as a semiconductor memory, a magnetic recording medium, or an optical recording medium. Alternatively, the units included in the processor 53 may be implemented in the route planner 5 as separate integrated circuits, microprocessors, or firmware.

The detection unit 531 acquires surrounding data representing a situation in the surroundings of the vehicle 1 from the surrounding camera 2 via the communication interface 51. The detection unit 531 also detects a pedestrian from the surrounding data.

The detection unit 531 detects a pedestrian from the surrounding data by inputting the acquired surrounding data to a classifier that has been trained to detect a pedestrian.

The classifier may be, for example, a convolutional neural network (CNN) including a plurality of convolution layers connected in series from the input toward the output such as a YOLO (You Only Look Once) or SSD (Single Shot MultiBox Detector). A CNN that has been trained in accordance with a predetermined training technique such as backpropagation, using a large amount of data including pedestrians as training data operates as a classifier to detect a pedestrian from the data. A machine learning algorithm such as a support vector machine (SVM) or AdaBoost may be used as a classifier. An SVM that has been trained to determine a support vector for discriminating whether various regions in the surrounding data include pedestrians operates as a classifier for detecting a pedestrian.

The detection unit 531 identifies a position of the detected pedestrian in a global coordinate system. For example, the detection unit 531 performs a process for viewpoint conversion of the received surrounding data using information such as the mounting position of the surrounding camera 2 on the vehicle 1 and creates a bird's eye view. The information such as the mounting position of the surrounding camera 2 on the vehicle 1 may be stored in advance in the memory 52. the detection unit 531 also receives positioning signals from the GNSS receiver 3 and acquires as map information the information representing the positions of lane lines and other features in the vicinity of its position indicated in the received positioning signals from the storage device 4 through the communication interface 51. The detection unit 531 estimates the position and orientation of the vehicle 1 by matching the positions of features in the created bird's eye view with the positions of features in the acquired map information. The detection unit 531 identifies the position of a pedestrian represented in the created bird's eye view based on the estimated position and orientation of the vehicle 1.

The detection unit 531 may further detect a facial orientation of a pedestrian detected from the surrounding data. For example, the detection unit 531 detects facial feature points of the pedestrian from the surrounding data by inputting the acquired surrounding data to a classifier that has been trained in advance to detect facial feature points of pedestrians. The classifier may be a CNN that has been trained in advance by using a large amount of data including facial feature points of the pedestrians as training data. The detection unit 531 compares the detected facial feature points of a pedestrian against a standard 3D model of a face and detects, as the facial orientation of a pedestrian detected from the surrounding data, the facial orientation in the 3D model with the best-fit positions of facial feature points to the positions detected from the surrounding data.

The identification unit 532 identifies a pause-by object in the surroundings of the vehicle 1.

The identification unit 532 receives positioning signals from the GNSS receiver 3 and acquires information representing the position of a pause-by object in the vicinity of its position indicated in the received positioning signals from the storage device 4 via the communication interface 51. The identification unit 532 identifies the position of the pause-by object based on the acquired information.

The identification unit 532 may detect the pause-by object from the surrounding data and identify the position of the detected pause-by object. For example, the identification unit 532 detects the pause-by object from the surrounding data by inputting the acquired surrounding data to a classifier that has been trained in advance to detect a pause-by object. The classifier may be a CNN that has been trained in advance by using a large amount of data including various pause-by objects as training data. The identification unit 532 can identify the position of the detected pause-by object by a technique similar to identification of the position of the pedestrian by the detection unit 531.

The creation unit 533 creates the travel route to keep the enough distances to the features and pedestrians in the surroundings at a predetermined distance ahead on the road RD1 on which the vehicle 1 travels. If a pedestrian is detected from the surrounding data and the identified position of a pause-by object is not in the vicinity of the pedestrian, the creation unit 533 creates a travel route on which the vehicle 1 travels assuming the pedestrian will enter the road on which the vehicle 1 travels. Comparatively, if the pedestrian is detected from the surrounding data and the identified position of the pause-by object is in the vicinity of the pedestrian, the planning unit 533 creates a travel route on which the vehicle 1 travels assuming the pedestrian will not enter the road on which the vehicle 1 travels.

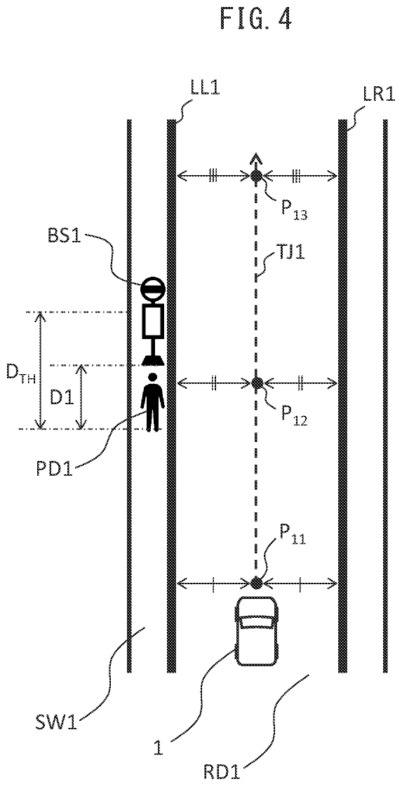

FIG. 4 schematically illustrates a first example of route planning. In the first example of route planning, the vehicle 1 is traveling on a road RD1 defined by a pair of lane lines LL1, LR1. A pedestrian PD1 is present on a sidewalk SW1 provided adjoining the road RD1.

The detection unit 531 of the route planner 5 mounted on the vehicle 1 detects the pedestrian PD1 from the surrounding data generated by the surrounding camera 2. The identification unit 532 of the route planner 5 also identifies a bus stop BS1 in the surroundings of the vehicle 1. It is reasonably expected that a pedestrian in the surroundings of the bus stop may wish to get on the bus and pause thereby. Therefore, the bus stop BS1 corresponds to a pause-by object.

The creation unit 533 of the route planner 5 determines that the position of a pause-by object is in the vicinity of a pedestrian if for example the distance between the identified position of the pause-by object and the detected pedestrian is shorter than a predetermined distance threshold (for example 10 m). In the first example of route planning shown in FIG. 4, the distance D1 between the bus stop BS1 and the pedestrian PD1 is shorter than the distance threshold D_{TH} stored in advance in the memory 52. Therefore, the creation unit 533 of the route planner 5 determines that the position of the bus stop BS1 is in the vicinity of the pedestrian PD1.

The creation unit 533 creates a travel route on which the vehicle 1 will travel assuming the pedestrian PD1 will not enter the road RD1. That is, in the creation of the travel route, the creation unit 533 presumes that the pedestrian PD1 will not approach the vehicle 1 beyond the lane line LL1 of the sidewalk SW1 side where the pedestrian PD1 is detected among the pair of lane lines LL1, LR1.

The creation unit 533 keeps the distances to the pair of lane lines LL1, LR1 as much as possible, for example, by setting points P₁₁, P₁₂, P₁₃ on center points of the pair of lane lines LL1, LR1 with a first priority. The creation unit 533 creates the travel route TJ1 so as to pass through the points P₁₁, P₁₂, P₁₃.

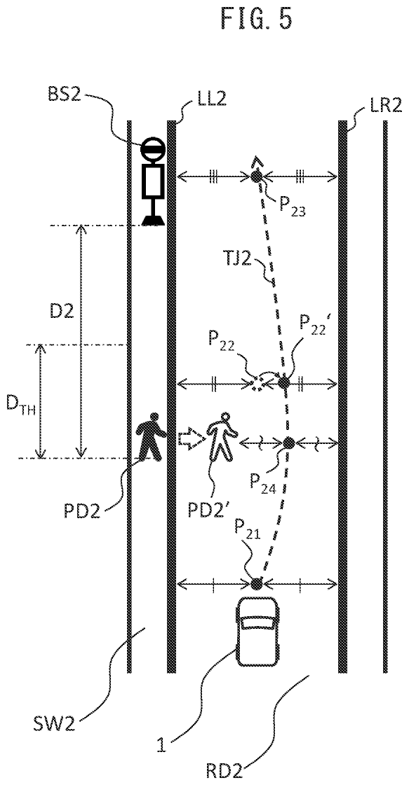

FIG. 5 schematically explains a second example of route planning. In the second example of route planning, the vehicle 1 is traveling on a road RD2 defined by a pair of lane lines LL2, LR2. A pedestrian PD2 is present on a sidewalk SW2 provided adjoining the road RD2.

The detection unit 531 of the route planner 5 mounted on the vehicle 1 detects the pedestrian PD2 from the surrounding data generated by the surrounding camera 2. The identification unit 532 of the route planner 5 also identifies a bus stop BS2, one of the pause-by objects, in the surroundings of the vehicle 1.

In the second example of route planning shown in FIG. 5, the distance D2 between the bus stop BS2 and the pedestrian PD2 is longer than a distance threshold D_{TH}. Therefore, the creation unit 533 of the route planner 5 determines that the position of the bus stop BS2 is not in the vicinity of the pedestrian PD2.

The creation unit 533 creates a travel route over which the vehicle 1 will travel assuming the pedestrian PD2 will enter the road RD2. That is, in the planning of the travel route, the creation unit 533 presumes that the pedestrian PD2 will approach the vehicle 1 beyond the lane line LL2 at the sidewalk SW2 side where the pedestrian PD2 is detected in the pair of lane lines LL2, LR2.

The creating unit 533 estimates the time required for the vehicle 1 to most approach the pedestrian PD2 by dividing the distance from the position of the vehicle 1 to the position of the pedestrian PD2 by the speed of the vehicle 1. The creation unit 533 calculates the distance from the lane line LL2 on the road RD2 to the pedestrian PD2 after the elapse of a predetermined time by multiplying the estimated required time with a standard walking speed of pedestrians stored in the memory 52. The creation unit 533 estimates the position PD2′ of the pedestrian PD2. When the distance from the position PD2′ to the lane line LR2 at the opposite side from the lane line LL2 is shorter than a predetermined road width threshold, the creation unit 533 creates a travel route so as to stop before the position PD2′. When the distance from the position PD2′ to the lane line LR2 is longer than the predetermined road width threshold, the creation unit 533 sets the point P₂₄ corresponding to a center point of the position PD2′ and the lane line LR2 with a second priority higher than the first priority. The creation unit 533 sets the points P₂₁, P₂₂, P₂₃ as center points of the pair of lane lines LL2, LR2 so that the distances to the pair of lane lines LL2, LR2 become as large as possible. The creation unit 533 creates a travel route TJ2 so as to pass through the points P₂₁, P₂₂, P₂₃, P₂₄.

In this case, the creation unit 533 may change the positions of the points P₂₁, P₂₂, P₂₃ having the first priority so that the radii of curvature at the points become larger than a predetermined curvature threshold. In the second example of route planning of FIG. 5, the creation unit 533 changes the position of the point P₂₂ to P₂₂′ and creates a travel route TJ2 passing through the points P₂₁, P₂₄, P₂₂′, P₂₃ in that order.

The creation unit 533 may create a travel route assuming a pedestrian will not enter the road even if the pedestrian is detected and the identified position of the pause-by object is not in the vicinity of the pedestrian in the case where a facial orientation of the pedestrian is not toward the road.

As explained above, the detection unit 531 may further detect the facial orientation of a pedestrian detected from the surrounding data. For example, in the second example of the route planning shown in FIG. 5, when the detected facial orientation of the pedestrian PD2 is not toward the road RD2 (for example, is toward the vehicle 1), the creation unit 533 creates the travel route assuming the pedestrian PD2 will not enter the road RD2. By the creation unit 533 operating in this way, the route planner 5 can efficiently create a feasible travel route while securing safety of pedestrians.

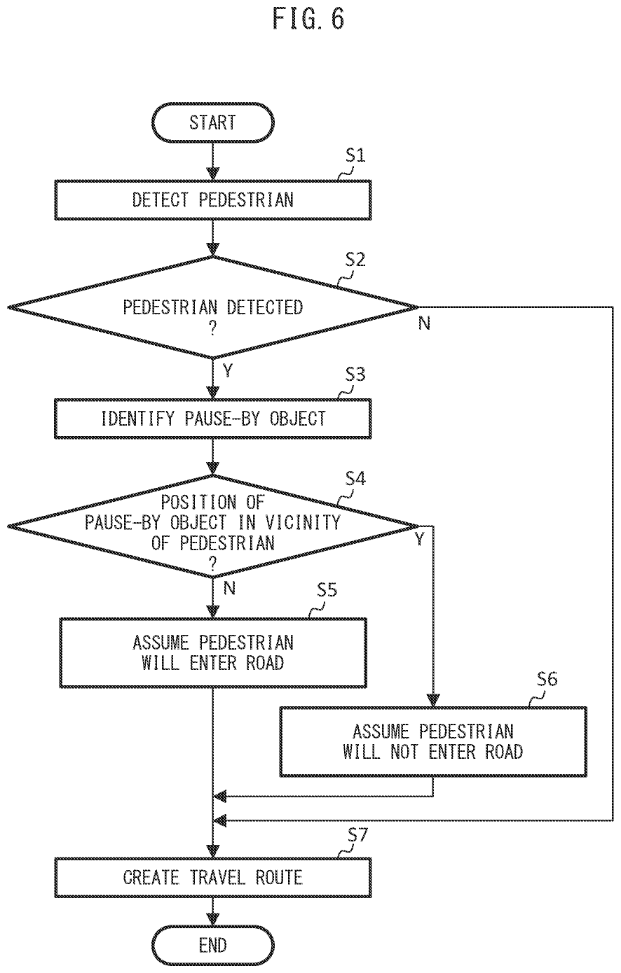

FIG. 6 is a flowchart of a process for route planning. The processor 53 of the route planner 5 repeatedly performs the process for route planning described below at predetermined intervals (for example, every 1/10 second) while the vehicle 1 is traveling under autonomous driving control.

First, the detection unit 531 of the processor 53 of the route planner 5 detects a pedestrian from surrounding data generated by the surrounding camera 2 (step S1).

The identification unit 532 of the processor 53 determines whether a pedestrian has been detected from the surrounding data (step S2). If a pedestrian has not been detected (step S2: N), the processing of the processor 53 proceeds to step S7 described below.

If a pedestrian has been detected (step S2: Y), the identification unit 532 identifies the position of a pause-by object in the surroundings of the vehicle 1 (step S3).

The creation unit 533 of the processor 53 determines whether the identified position of the pause-by object is in the vicinity of the pedestrian (step S4). If the position of the pause-by object is not in the vicinity of the pedestrian (step S4: N), the creation unit 533 assumes that the pedestrian will enter the road (step S5). If the position of the pause-by object is in the vicinity of the pedestrian (step S4: Y), the creation unit 533 assumes that the pedestrian will not enter the road (step S6).

The creation unit 533 creates the travel route of the vehicle 1 based on action assumed for the detected pedestrian or the situation of the surroundings in which no pedestrian is detected (step S7) and terminates the process for route planning. The travel route created by the process for route planning is used for autonomous drive control for at least part of the acceleration/deceleration and steering of the vehicle 1.

Such a process for route planning enables the route planner 5 to efficiently create a feasible travel route while securing safety of pedestrians.

According to a modification, the detection unit 531 may further detect an entry-restricting state from the surrounding data. The entry-restricting state is the state where entry of pedestrians into a road is restricted and includes, such as the existence of a guard rail, a pedestrian raising hand (probably hailing a taxi) and a plurality of pedestrians pausing in line.

The detection unit 531 detects an entry-restricting state from the surrounding data by inputting the acquired surrounding data to a classifier that has been trained in advance to detect states each included in the entry-restricting state. A CNN that has been trained in advance by using a large amount of data representing states each included in the entry-restricting state as training data can be used as the classifier.

If a pedestrian is detected and an entry-restricting state is detected, the creation unit 533 creates the travel route assuming the pedestrian will not enter the road.

The route planner 5 according to the present modification can more efficiently create a feasible travel route while securing safety of pedestrians.

Note that those skilled in the art can apply various changes, substitutions, and modifications without departing from the spirit and scope of the present disclosure.

What is claimed is:

1. A route planner comprising a processor configured to:
detect a pedestrian from surrounding data representing a situation of surroundings of a vehicle,
identify a position of a pause-by object in the surroundings of the vehicle prompting the pedestrian to pause, and
create a travel route over which the vehicle will travel when the pedestrian is detected, assuming the pedestrian will enter a road on which the vehicle will travel when the identified position of the pause-by object is not in a vicinity of the pedestrian, and assuming the pedestrian will not enter the road when the identified position of the pause-by object is in the vicinity of the pedestrian.

2. The route planner according to claim 1, wherein the processor,
in the detection, further detects a facial orientation of the pedestrian from surrounding data, and
in the creation, creates the travel route assuming the pedestrian will not enter the road even when the pedestrian is detected and the identified position of the pause-by object is not in the vicinity of the pedestrian in a case where the facial orientation of the pedestrian is not toward the road.

3. The route planner according to claim 1, wherein the processor,
in the detection, further detects an entry-restricting state restricting entry of the pedestrian to the road from the surrounding data, and
in the creation, creates the travel route assuming the pedestrian will not enter the road when the pedestrian is detected and the entry-restricting state is detected.

4. A method for route planning having a route planner creating a travel route of a vehicle execute a process comprising:
detecting a pedestrian from surrounding data representing a situation of surroundings of the vehicle,
identifying a position of a pause-by object in the surroundings of the vehicle prompting the pedestrian to pause,
creating a travel route over which the vehicle will travel when the pedestrian is detected, assuming the pedestrian will enter a road on which the vehicle will travel when the identified position of the pause-by object is not in a vicinity of the pedestrian, and assuming the pedestrian will not enter the road when the identified position of the pause-by object is in the vicinity of the pedestrian.

5. A non-transitory computer-readable medium having a computer program for route planning stored therein, the computer program causing a computer mounted on a vehicle to execute a process comprising:
detecting a pedestrian from surrounding data representing a situation of surroundings of the vehicle,
identifying a position of a pause-by object in the surroundings of the vehicle prompting the pedestrian to pause,
creating a travel route over which the vehicle will travel when the pedestrian is detected, assuming the pedestrian will enter a road on which the vehicle will travel when the identified position of the pause-by object is not in a vicinity of the pedestrian, and assuming the pedestrian will not enter the road when the identified position of the pause-by object is in the vicinity of the pedestrian.
